(19) United States
(12) Patent Application Publication
(10) Pub. No.: US 2025/0224960 A1
(43) Pub. Date: Jul. 10, 2025

(54) TASK EXECUTION METHOD FOR LARGE MODEL, ELECTRONIC DEVICE, AND STORAGE MEDIUM

(71) Applicant: Beijing Baidu Netcom Science Technology Co., Ltd., Beijing (CN)

(72) Inventors: Zhenyu LI, Beijing (CN); Liqi HE, Beijing (CN); Kaipeng DENG, Beijing (CN); Qingqing DANG, Beijing (CN); Yanlin SHA, Beijing (CN); Dianhai YU, Beijing (CN); Yanjun MA, Beijing (CN)

(21) Appl. No.: 19/089,853

(22) Filed: Mar. 25, 2025

(30) Foreign Application Priority Data
Jun. 19, 2024 (CN) 202410797493.X

(51) Int. Cl. G06F 9/38; G06F 9/30

(52) U.S. Cl. CPC G06F 9/3836; G06F 9/30036

(57) ABSTRACT

A task execution method and apparatus for a large model, an electronic device, and a storage medium are provided, which relate to a field of artificial intelligence, and in particular to fields of deep learning and large model technologies. The method includes: executing, according to a target feature to be processed, a collaborative computing task using a target computing unit, where the collaborative computing task includes a first collaborative task and a second collaborative task, the first collaborative task is used to process the target feature to be processed and a first collaborative sub-weight to obtain an intermediate collaborative feature, the second collaborative task is used to process the intermediate collaborative feature and a second collaborative sub-weight to obtain a target collaborative feature; and fusing a target basic feature and the target collaborative feature to obtain a next target feature to be processed

### CROSS-REFERENCE TO RELATED APPLICATION(S)

This application claims the benefit of Chinese Patent Application No. 202410797493.X filed on Jun. 19, 2024, the whole disclosure of which is incorporated herein by reference.

### TECHNICAL FIELD

The present disclosure relates to a field of artificial intelligence technology, and in particular, to fields of deep learning technology and large model technology.

### BACKGROUND

With the rapid development of artificial intelligence technology, large models may be used to process data in various scenarios such as intelligent customer service and knowledge query answering.

### SUMMARY

The present disclosure provides a task execution method for a large model, an electronic device, and a storage medium.

According to an aspect of the present disclosure, a task execution method for a large model is provided, including:
executing, according to a target feature to be processed, a collaborative computing task using a target computing unit to obtain a target collaborative feature, where the collaborative computing task includes a first collaborative task and a second collaborative task, the first collaborative task is configured to process the target feature to be processed and a first collaborative sub-weight to obtain an intermediate collaborative feature, the second collaborative task is configured to process the intermediate collaborative feature and a second collaborative sub-weight to obtain the target collaborative feature, and the first collaborative sub-weight and the second collaborative sub-weight are determined by processing a collaborative weight according to a matrix multiplication mechanism of a general matrix; and fusing a target basic feature and the target collaborative feature to obtain a next target feature to be processed, where the target basic feature is obtained by executing a basic computing task using the target computing unit, and the basic computing task is configured to process a basic weight and the target feature to be processed.

According to another aspect of the present disclosure, an electronic device is provided, including: at least one processor; and a memory communicatively coupled with the at least one processor; where the memory stores instructions executable by the at least one processor, and the instructions, when executed by the at least one processor, cause the at least one processor to implement the method provided according to embodiments of the present disclosure.

According to another aspect of the present disclosure, a non-transitory computer readable storage medium storing computer instructions is provided, where the computer instructions are configured to cause a computer to implement the method provided according to embodiments of the present disclosure.

It should be understood that the content described in this part is not intended to identify the key or important features of embodiments of the present disclosure, nor is it intended to limit the scope of the present disclosure. Other features of the present disclosure will be easily understood through the following specification.

### BRIEF DESCRIPTION OF THE DRAWINGS

The accompanying drawings are used to better understand this solution, which do not constitute a limitation on the present disclosure, in which:

FIG. 1 schematically shows an exemplary system architecture to which a task execution method and apparatus may be applied according to an embodiment of the present disclosure;

FIG. 2 schematically shows a flowchart of a task execution method for a large model according to an embodiment of the present disclosure;

FIG. 3 schematically shows a schematic diagram of a principle of a task execution method for a large model according to an embodiment of the present disclosure;

FIG. 4 schematically shows a schematic diagram of a principle of a task execution method for a large model according to another embodiment of the present disclosure;

FIG. 5 schematically shows a flowchart of a task execution method for a large model according to another embodiment of the present disclosure;

FIG. 6 schematically shows a diagram of an application scene of a task execution method for a large model according to an embodiment of the present disclosure;

FIG. 7 schematically shows a schematic diagram of a principle of a task execution method for a large model according to another embodiment of the present disclosure;

FIG. 8 schematically shows a block diagram of a task execution apparatus for a large model according to an embodiment of the present disclosure;

FIG. 9 schematically shows a block diagram of a task execution device for a large model according to an embodiment of the present disclosure; and

FIG. 10 schematically shows a block diagram of an electronic device that may be used to implement a task execution method for a large model according to an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those of ordinary skill in the art should realize that various changes and modifications may be made to embodiments described herein without departing from the scope and spirit of the present disclosure. Likewise, for clarity and conciseness, descriptions of well-known functions and structures are omitted in the following description.

In the technical solution of the present disclosure, collecting, storing, using of the personal information of the user involved in the present disclosure all comply with the relevant laws and regulations, have adopted necessary confidentiality measures and do not violate the public order and morals.

In the field of deep learning, the applications of large models are constantly expanding. However, training or inference costs of the large models are high and deployment difficulty is high. For example, the large models may include Large Language Model (LLM), Large Image Model, and Large Audio Model, etc. The Large Language Model demonstrates super text processing capabilities. However, since the scale of model parameters of the large models is larger, the number of model parameters may reach hundreds of millions or even billions, the large models usually require to consume a large amount of computing resources during the process of executing computing tasks.

Embodiments of the present disclosure provide a task execution method and apparatus for a large model, a task execution device for a large model, an electronic device, a storage medium and a program product. The task execution method for a large model includes: executing a collaborative computing task using a target computing unit to obtain a target collaborative feature according to a target feature to be processed, where the collaborative computing task includes a first collaborative task and a second collaborative task, the first collaborative task is used to process the target feature to be processed and a first collaborative sub-weight to obtain an intermediate collaborative feature, the second collaborative task is used to process the intermediate collaborative feature and a second collaborative sub-weight to obtain the target collaborative feature, and the first collaborative sub-weight and the second collaborative sub-weight are determined by processing a collaborative weight according to a matrix multiplication mechanism of a general matrix; and fusing a target basic feature and the target collaborative feature to obtain a next target feature to be processed, where the target basic feature is obtained by executing a basic computing task using the target computing unit, and the basic computing task is used to process a basic weight and the target feature to be processed.

According to embodiments of the present disclosure, by dividing weight parameters of the large model into a basic weight and a collaborative weight, it is possible to use the basic weight of the general basic model and the collaborative weight related to the specified personalized task to execute the computing task that the large model needs to execute, to use the general basic model to improve the flexibility and adaptability of the reasoning process of the large model for executing personalized requirements during training or application. Furthermore, the collaborative weight is determined as the first collaborative sub-weight and the second collaborative sub-weight through a matrix multiplication mechanism based on a general matrix, so that a matrix dimension of the first collaborative sub-weight and a matrix dimension of the second collaborative sub-weight are both smaller than a matrix dimension of the collaborative weight, thereby causing a sum of the computing amount of the first collaborative task and the second collaborative task less than the computing amount of directly using the collaborative weight to execute the collaborative computing task, thereby reducing the computing overhead of the target computing unit of the large model in the process of executing computing tasks, reducing computing energy consumption, and improving the computing efficiency of the large model.

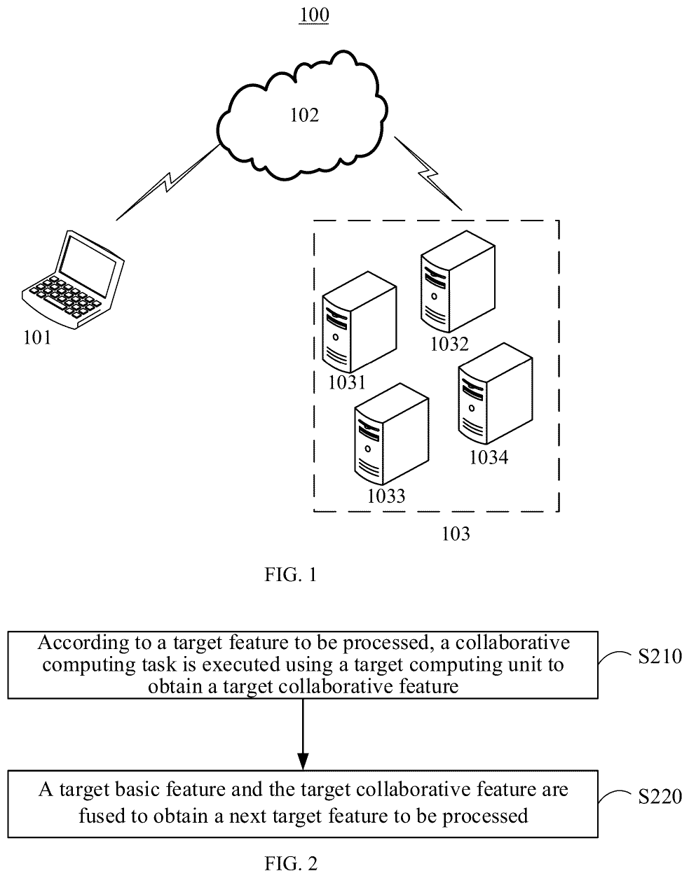

FIG. 1 schematically shows an exemplary system architecture to which a task execution method and apparatus may be applied according to an embodiment of the present disclosure.

It should be noted that, FIG. 1 is merely an example of a system architecture to which the embodiment of the present disclosure may be applied, to help those skilled in the art understand the technical content of the present disclosure, but it does not mean that the embodiments of the present disclosure cannot be used in other devices, systems, environments or scenarios.

As shown in FIG. 1, the system architecture according to this embodiment may include a terminal device 101, a network 102, and a server cluster 103. The network 102 is used as a medium for providing a communication link between the terminal device 101 and the server cluster 103. The network 102 may also be used as a medium for providing a communication link within the server cluster 103. The network 102 may include various connection types, such as a wired and/or wireless communication link, and so on.

The user may use the terminal device 101 to interact with the server cluster 103 through the network 102 to receive or send messages, etc. For example, the terminal device 101 may send a request for training a deep learning model to the server cluster 103 through the network 102.

Various communication client applications may be installed on the terminal device 101, such as knowledge reading applications, web browser applications, search applications, instant messaging tools, email clients and/or social platform software (for example only).

The terminal device 101 may be various electronic devices having display screens and supporting web browsing, including but not limited to smartphones, tablet computers, laptop computers, desktop computers, and the like.

The server cluster 103 may include a server that provides various services, such as a background management server that provides support for requests sent by users using the terminal device 101 (for example only).

The server cluster 103 may include a cloud server, also referred to as a cloud computing server or cloud host, which is a host product in the cloud computing service system to solve the defects of difficult management and weak business scalability in traditional physical hosts and VPS services (“Virtual Private Server”, or “VPS” for short). The server may also be a server of a distributed system, or a server combined with a blockchain.

The server cluster 103 includes a plurality of server nodes 1031, 1032, 1033 and 1034, each of which includes one or more hardware devices. The server cluster 103 or the server node may be used to execute the task execution method for a large model provided by the present disclosure, so as to realize the deployment, reasoning or training for the large model with lower computing resources and storage resources.

It may be understood that the system architecture of the present disclosure is described above, and the method of the present disclosure will be described below.

It should be understood that the number of terminal devices, networks and servers in FIG. 1 is only illustrative. Any number of terminal devices, networks and servers may be provided according to implementation requirements.

FIG. 2 schematically shows a flowchart of a task execution method for a large model according to an embodiment of the present disclosure.

As shown in FIG. 2, the task execution method for a large model includes operations S210 to S220.

In operation S210, according to a target feature to be processed, a collaborative computing task is executed using a target computing unit to obtain a target collaborative feature.

In operation S220, a target basic feature and the target collaborative feature are fused to obtain a next target feature to be processed.

According to embodiments of the present disclosure, the target computing unit may include at least one of a central processing unit (CPU), a graphics processing unit (GPU) and an artificial intelligence computing unit. The artificial intelligence computing unit may include at least one of a neural network processing unit (NPU), a tensor processing unit (TPU) and a Kunlun Core.

According to embodiments of the present disclosure, the computing task may include a neuron computing task executed by a large model, or may also include a computing task executed by a processing layer of the large model, such as an attention task that the large model needs to execute.

According to embodiments of the present disclosure, the computing tasks of the large model may include collaborative computing tasks and basic computing tasks. The basic computing task may be understood as a computing task executed based on a basic weight of a basic model (also referred to as a Base Model) in the large model. The collaborative computing task may be understood as a computing task executed based on a collaborative weight of a collaborative model in the large model.

According to embodiments of the present disclosure, the collaborative weight may be model parameters obtained by fine-tuning the large model containing the basic model. The computing task may be executed based on the basic weight and the fine-tuned collaborative weight, thereby achieving reasoning tasks such as text prediction and image generation for the large model.

According to embodiments of the present disclosure, the collaborative weight may also be model parameters to be fine-tuned in the large model built based on the basic model. During the process of fine-tuning the large model, the large model may be fine-tuned by adjusting only the collaborative weight, thereby achieving reasoning tasks such as text prediction and image generation for the large model based on the fine-tuned collaborative weight and basic weight.

According to embodiments of the present disclosure, the collaborative computing task includes a first collaborative task and a second collaborative task. The first collaborative task is used to process the target feature to be processed and a first collaborative sub-weight to obtain an intermediate collaborative feature. The second collaborative task is used to process the intermediate collaborative feature and a second collaborative sub-weight to obtain the target collaborative feature.

According to embodiments of the present disclosure, the first collaborative sub-weight and the second collaborative sub-weight are determined by processing a collaborative weight according to a matrix multiplication mechanism of a general matrix.

According to embodiments of the present disclosure, the first collaborative sub-weight and the second collaborative sub-weight are determined according to the matrix multiplication mechanism of the general matrix, which may be understood as dividing the collaborative weight W_LoRA into a first collaborative sub-weight W_LoRA_A and a second collaborative sub-weight W_LoRA_B based on a GEMM (GEneral Matrix to Matrix Multiplication) mechanism. A matrix dimension of the first collaborative sub-weight W_LoRA_A and a matrix dimension of the second collaborative sub-weight W_LoRA_B are both smaller than a matrix dimension of the collaborative weight W_LoRA. Therefore, a computing task of multiplying the collaborative weight W_LoRA with the target feature to be processed may be determined as a first collaborative task of multiplying the first collaborative sub-weight W_LoRA_B with the target feature to be processed, and a second collaborative task of multiplying the intermediate collaborative feature with the second collaborative sub-weight W_LoRA_B.

It should be understood that the collaborative computing task may be understood as an LoRA (LowRank Adaptation) computing task, so as to use the collaborative computing task to assist basic computing tasks to accelerate the computing efficiency of large model that executes computing tasks and save the computing overhead of the target computing unit.

According to embodiments of the present disclosure, the target basic feature may be obtained by executing the basic computing task using the target computing unit, and the basic computing task is used to process the basic weight and the target feature to be processed.

According to embodiments of the present disclosure, the basic computing task may include performing a matrix multiplication operation on the basic weight and the target feature to be processed to obtain the target basic feature. A fusion result between the target basic feature and the target collaborative feature may represent a computation result of combining the associated basic weight and collaborative weight in the current large model.

According to embodiments of the present disclosure, the target basic feature and the target collaborative feature are fused to obtain a next target feature to be processed. It may include adding the target basic feature and the target collaborative feature to obtain the next target feature to be processed. It should be understood that the next target feature to be processed may also be used to execute the next collaborative computing task and basic computing task of the large model.

It should be noted that in the embodiments of the present disclosure, the collaborative task may be understood as the collaborative computing task, and the basic task may be understood as the basic computing task.

According to embodiments of the present disclosure, the target feature to be processed may be determined according to an initial feature. For example, if the collaborative computing task and the basic computing task are a first computing task in the large model, the target feature to be processed may be obtained according to the initial feature. The initial feature may be obtained according to input data. The input data may be text data. The input text data may be tokenized and embedded to obtain the initial feature.

According to embodiments of the present disclosure, the target feature to be processed may also be obtained by the target computing unit executing a previous collaborative computing task and a previous basic computing task. For example, if the collaborative computing task and the basic computing task are an n^{th} computing task among N computing tasks of the large model, the target feature to be processed may be obtained by the target computing unit executing an (n−1)^{th} computing task (an (n−1)^{th} collaborative computing task and an (n−1)^{th} basic computing task), where N may be an integer greater than 1 and less than N.

For the convenience of explaining the task execution method provided by the embodiments of the present disclosure, in this embodiment, the first collaborative sub-weight W_LoRA_A may be represented as a matrix A, and a dimension of the matrix A is m*LoRA_rank. The second collaborative sub-weight W_LoRA_B may be represented as a matrix B, and a dimension of the matrix B is n*LoRA_rank. The LoRA_rank may be represented as a rank matrix associated with the collaborative weight. It should be understood that the collaborative weight W_LoRA=A*B. The m*n may represent the dimension of the collaborative weight matrix. The target feature to be processed may be represented as a matrix MB1, the dimension of the matrix MB1 is m*n, and the basic weight may be represented as W_Base.

According to embodiments of the present disclosure, the target computing unit may perform a matrix multiplication operation on the first collaborative sub-weight and the target feature to be processed to obtain the intermediate collaborative feature. For example, a matrix multiplication may be performed on the first collaborative sub-weight (the dimension is m*LoRA_rank) and the target feature to be processed (the matrix dimension is m*k), and the dimension of the obtained intermediate collaborative feature may be m*lora_rank.

According to embodiments of the present disclosure, the target computing unit may perform a matrix multiplication operation on the second collaborative sub-weight and the intermediate collaborative feature to obtain the next target feature to be processed. For example, a matrix multiplication may be performed on the second collaborative sub-weight B (the matrix dimension is n*lora_rank) and the intermediate collaborative feature (the matrix dimension is m*lora_rank), and the dimension of the obtained next target feature to be processed may be m*n.

According to embodiments of the present disclosure, since the dimension (lora_rank) of the rank of the first collaborative sub-weight and the second collaborative sub-weight may be less than m or n, collaborative tasks are determined as sequentially executed first collaborative task and second collaborative task, which may reduce the dimension of matrix multiplication computing for the first collaborative task and the second collaborative task, thereby reducing the computing costs of the target computing unit executing collaborative tasks, improving the computing efficiency of the target computing unit, reducing the energy consumption level generated by the target computing unit during the process of executing computing tasks of the large model, and causing the large model to be loaded into electronic devices with lower computational performance.

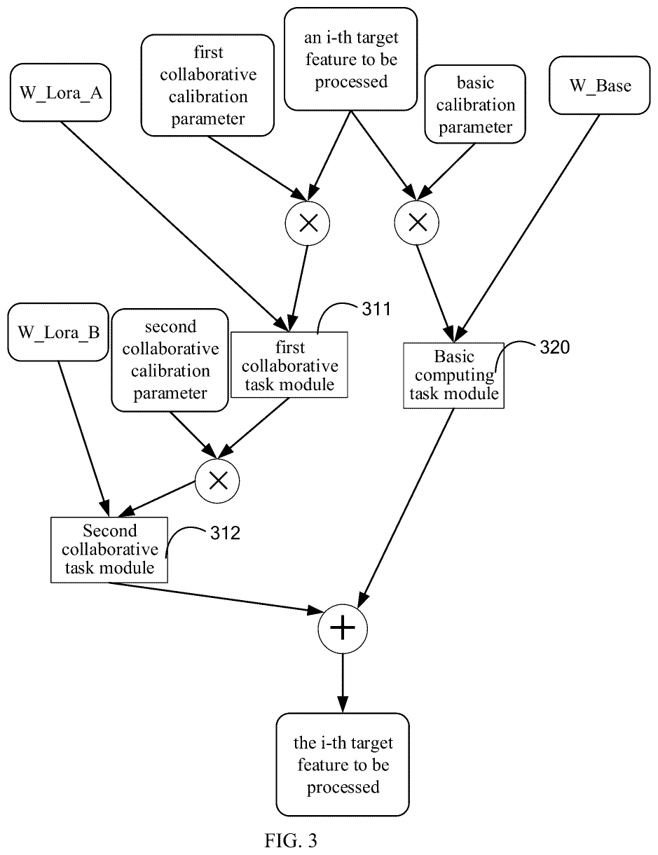

FIG. 3 schematically shows a schematic diagram of a principle of a task execution method for a large model according to an embodiment of the present disclosure.

As shown in FIG. 3, an i^{th} target feature to be processed may be the target feature being processed by the large model. The target computing unit may multiply the i^{th} target feature to be processed with a first collaborative calibration parameter to obtain a calibrated i^{th} target feature to be processed. The calibrated i^{th} target feature to be processed and a calibrated first collaborative sub-weight W_Lora_A may be input into a first collaborative task module 311. The first collaborative task module 311 may use the target computing unit to execute the first collaborative task to obtain an intermediate collaborative feature. The calibrated first collaborative sub-weight W_Lora_A may be obtained offline based on a division between an initial first collaborative sub-weight and the first collaborative calibration parameter after computing and obtaining the initial first collaborative sub-weight.

As shown in FIG. 3, the intermediate collaborative feature may be multiplied with a second collaborative calibration parameter to obtain a calibrated intermediate collaborative feature. The calibrated intermediate collaborative feature and the calibrated second collaborative sub-weight W_LoRA_B may be input into a second collaborative task module 312. The second collaborative task module 312 may use the target computing unit to execute the second collaborative task to obtain a calibrated target collaborative feature. The calibrated second collaborative sub-weight W_LoRA_B may be obtained offline based on a division between an initial second collaborative sub-weight and the second collaborative calibration parameter after computing and obtaining the initial second collaborative sub-weight.

As shown in FIG. 3, the target computing unit may also multiply the i^{th} target feature to be processed with a basic calibration parameter to obtain a calibrated i^{th} basic calibration feature. The i^{th} basic calibration feature and a calibrated basic weight W_Base may be input into a basic computing task module 320. The basic computing task module 320 may use the target computing unit to execute the basic computing task to obtain a calibrated target basic feature. By adding the calibrated target collaborative feature to the calibrated target basic feature, the i^{th} target feature to be processed may be obtained.

According to embodiments of the present disclosure, the first collaborative task may include a plurality of first collaborative sub-tasks.

According to embodiments of the present disclosure, executing the collaborative computing task using the target computing unit according to the target feature to be processed may include: reading the first collaborative sub-weight and a target sub-feature to be processed corresponding to a first collaborative sub-task from a target storage unit using the target computing unit.

According to embodiments of the present disclosure, the target sub-feature to be processed may be obtained by dividing the target feature to be processed. For example, the target feature to be processed may be divided into rows and/or columns according to a preset division strategy to obtain the target sub-feature to be processed. For example, the target feature to be processed is a feature matrix with a dimension of 1000*1000, and a target sub-matrix to be processed may be a matrix with a dimension of 1000*100.

According to embodiments of the present disclosure, based on the first collaborative sub-weight and the target sub-feature to be processed, the first collaborative sub-task is executed using the target computing unit to obtain a first intermediate collaborative sub-feature.

According to embodiments of the present disclosure, the plurality of first collaborative sub-tasks are associated with the same first collaborative sub-weight. For example, an i^{th} first collaborative sub-task may be that the target computing unit is used to perform a matrix multiplication operation on the same first collaborative sub-weight and an i^{th} target sub-feature to be processed to obtain an i^{th} first intermediate collaborative sub-feature, where i may be a positive integer greater than 0.

According to embodiments of the present disclosure, in the case of dividing N target sub-features to be processed from the target feature to be processed, the target computing unit may be used to perform a matrix multiplication on the first collaborative sub-weight with the N target sub-features to be processed respectively to obtain N first intermediate collaborative sub-features. The N first intermediate collaborative sub-features may correspond to N first collaborative sub-tasks respectively.

In an example, N target computing units may be provided, and an i^{th} target computing unit may execute the i^{th} first collaborative sub-task. For example, the i^{th} target computing unit may perform a matrix multiplication operation on the first collaborative sub-weight and the i^{th} target sub-feature to be processed to obtain the i^{th} first intermediate collaborative sub-feature.

According to embodiments of the present disclosure, the first intermediate collaborative sub-features obtained by the plurality of target computing units are written into the target storage unit, which may obtain an intermediate collaborative feature without communication or interaction between the plurality of target computing units, thereby avoiding an intermediate value of the intermediate collaborative feature obtained by the transmission and computation between the plurality of target computing units, which causes the target computing units to generate communication overhead. In this case, by dividing the target feature to be processed with larger tensor dimension into the target sub-features to be processed with smaller tensor dimension, the plurality of target computing units are used to execute a part of the first collaborative task respectively, so as to execute the plurality of first collaborative sub-tasks in parallel using the plurality of target computing units, thereby obtaining the intermediate collaborative feature. In this way, it is possible to reduce the impact of computing power performance such as the number of threads and memory space of the target computing units on the computing efficiency of executing the first collaborative task during the process of executing the tasks of the large model, and improve the execution efficiency of the entire task of the large model.

According to embodiments of the present disclosure, the intermediate collaborative feature may be determined according to first intermediate collaborative sub-features corresponding to the plurality of first collaborative sub-tasks respectively. The plurality of first intermediate collaborative sub-features may be fused. For example, the plurality of first intermediate collaborative sub-features may be allreduced according to the divided dimensions to obtain the intermediate collaborative feature. The intermediate collaborative feature may be stored in the target storage unit.

According to embodiments of the present disclosure, the second collaborative task may include a plurality of second collaborative sub-tasks.

According to embodiments of the present disclosure, executing the collaborative computing task using the target computing unit according to the target feature to be processed may further include: reading a second intermediate collaborative sub-feature corresponding to a second collaborative sub-task from a target storage unit using the target computing unit; executing the second collaborative sub-task using the target computing unit based on the second intermediate collaborative sub-feature and the second collaborative sub-weight to obtain a target collaborative sub-feature.

According to embodiments of the present disclosure, the second intermediate collaborative sub-feature is determined according to the intermediate collaborative feature. For example, the intermediate collaborative feature may be divided into rows and/or columns based on a preset division strategy to obtain the second intermediate collaborative sub-feature. For example, the intermediate collaborative feature is feature matrix with a dimension of 1000*1000, and the second intermediate collaborative sub-feature may be a matrix with a dimension of 1000*100.

According to embodiments of the present disclosure, the plurality of second collaborative sub-tasks are associated with the same second collaborative sub-weight. For example, a j^{th} second collaborative sub-task may be that the target computing unit is used to perform a matrix multiplication operation on the same second collaborative sub-weight and a j^{th} second intermediate collaborative sub-feature to obtain a j^{th} target collaborative sub-feature.

In an example, N target computing units may be provided, and a j^{th} target computing unit may execute the j^{th} second collaborative sub-task. For example, the j^{th} target computing unit may perform a matrix multiplication operation on the second collaborative sub-weight and the j^{th} second intermediate collaborative sub-feature to obtain the j^{th} target collaborative sub-feature.

According to embodiments of the present disclosure, the target collaborative sub-features obtained by the plurality of target computing units may be written into the target storage unit, which may obtain the target collaborative feature without communication or interaction between the plurality of target computing units, thereby avoiding the intermediate value of the target collaborative feature obtained by the transmission and computation between the plurality of target computing units, which causes the target computing units to generate communication overhead. In this case, by dividing the intermediate collaborative feature with larger tensor dimension into the second collaborative sub-features with smaller tensor dimension, the plurality of target computing units are used to execute a part of the second collaborative task respectively, so as to execute the plurality of second collaborative sub-tasks in parallel using the plurality of target computing units, thereby obtaining the target collaborative feature. In this way, it is possible to reduce the impact of computing power performance such as the number of threads and memory space of the target computing units on the computing efficiency of executing the second collaborative task during the process of executing the tasks of the large model, and improve the execution efficiency of the entire task of the large model.

According to embodiments of the present disclosure, the target collaborative feature may be determined according to second intermediate collaborative sub-features corresponding to the plurality of second collaborative sub-tasks respectively. For example, the plurality of second intermediate collaborative sub-features may be matrix added by calling an integration function to obtain the target collaborative feature.

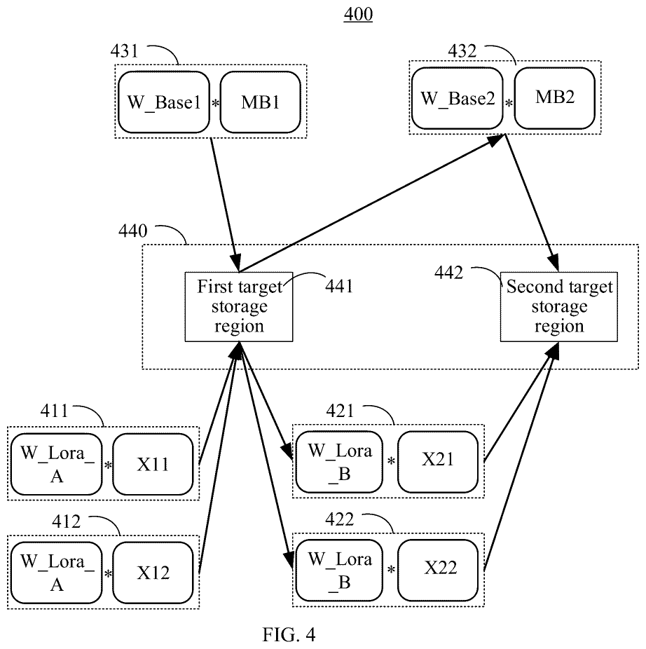

FIG. 4 schematically shows a schematic diagram of a principle of a task execution method for a large model according to another embodiment of the present disclosure.

As shown in FIG. 4, an electronic device 400 may include a plurality of target computing units and a target storage unit 440. Among the plurality of target computing units 411, 412, 421, 422, 431 and 432, the target computing units 411 and 412 may be used to execute the first collaborative sub-task, the target computing units 421 and 422 may be used to execute the second collaborative sub-task, and the target computing units 431 and 432 may be used to execute the basic computing task. The target storage unit 440 may include a first target storage region 441 and a second target storage region 442.

As shown in FIG. 4, the target computing unit 411 may read a first collaborative sub-weight W_Lora_A and a first target sub-feature to be processed X11 from the target storage unit 440, and perform a matrix multiplication operation on the first collaborative sub-weight W_Lora_A and the first target sub-feature to be processed X11 in the target computing unit 411 to obtain a first intermediate collaborative sub-feature. The target computing unit 412 may read the first collaborative sub-weight W_Lora_A and a second target sub-feature to be processed X12 from the target storage unit 440, and perform a matrix multiplication operation on the first collaborative sub-weight W_Lora_A and the second target sub-feature to be processed X12 in the target computing unit 412 to obtain a second intermediate collaborative sub-feature. The first intermediate collaborative sub-feature and the second intermediate collaborative sub-feature may be written into the first target storage region 441. The integration function may be called to process the first intermediate collaborative sub-feature and the second intermediate collaborative sub-feature to obtain an intermediate collaborative feature, and the intermediate collaborative feature may be divided based on a preset division strategy to obtain a first second intermediate collaborative sub-feature X21 and a second second intermediate collaborative sub-feature X22.

As shown in FIG. 4, the target computing unit 421 may read a second collaborative sub-weight W_Lora_B and a first second intermediate collaborative sub-feature X21 from the target storage unit 440, and perform a matrix multiplication on the second collaborative sub-weight W_Lora_B and the first second intermediate collaborative sub-feature X21 in the target computing unit 421 to obtain a first target collaborative sub-feature. The target computing unit 422 may read the second collaborative sub-weight W_Lora_B and a second second intermediate collaborative sub-feature X22 from the target storage unit 440, and perform a matrix multiplication operation on the second collaborative sub-weight W_Lora_B and the second second intermediate collaborative sub-feature X22 in the target computing unit 422 to obtain a second target collaborative sub-feature. The first target collaborative sub-feature and the second target collaborative sub-feature may be written into the second target storage region 442. The integration function may be called to process the first target collaborative sub-feature and the second target collaborative sub-feature to obtain a target collaborative feature.

As shown in FIG. 4, the target computing unit 431 may read a first basic sub-weight W_Base1 and a target feature to be processed MB1 from the target storage unit 440. The target computing unit 431 may perform a matrix multiplication operation on the first basic sub-weight W_Base1 and the target feature to be processed MB1 to obtain an intermediate basic feature MB2. The intermediate basic feature MB2 may be written into the first target storage region 441. The target computing unit 432 may read a second basic sub-weight W_Base2 and the intermediate basic feature MB2 from the first target storage region 441. The target computing unit 432 may perform a matrix multiplication on the second basic sub-weight W_Base2 and the intermediate basic feature MB2 to obtain a target basic feature. The target basic feature may be written into the second target storage region 442. By calling the integration function to process the target basic feature and the target collaborative feature, a next target feature to be processed may be obtained.

According to embodiments of the present disclosure, a basic weight W_Base may be processed based on a matrix multiplication mechanism of a general matrix to obtain the first basic sub-weight W_Base1 and the second basic sub-weight W_Base2.

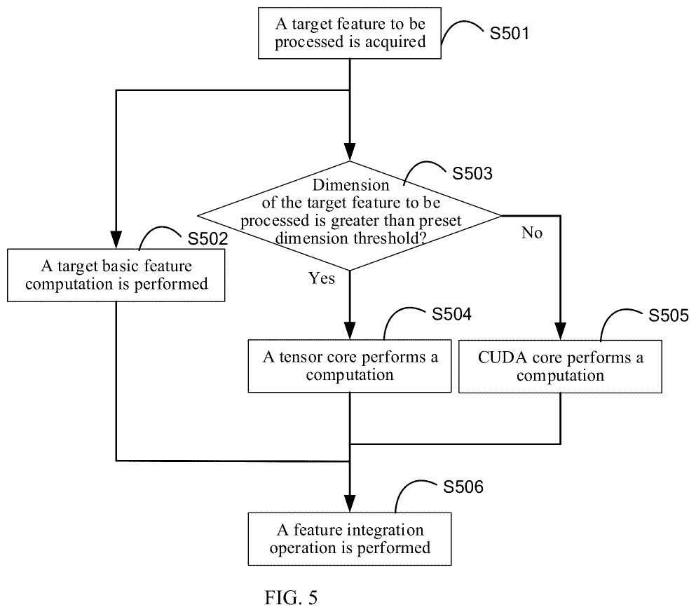

FIG. 5 schematically shows a flowchart of a task execution method for a large model according to another embodiment of the present disclosure.

As shown in FIG. 5, the task execution method may further include operation S501 to operation S506.

In operation S501, a target feature to be processed is acquired. A tensor dimension of the target feature to be processed may be m*k.

In operation S502, a target basic feature computation is performed. For example, the target computing unit may be used to process a basic weight and the target feature to be processed to obtain the target basic feature.

In operation S503, whether a dimension of the target feature to be processed is greater than a preset dimension threshold is determined. For example, it may be determined whether the dimension m of the target feature to be processed is greater than the preset dimension threshold.

In a case that the determination result of operation S503 is yes, operation S504 may be executed, where a tensor core performs a computation. For example, the first collaborative task and the second collaborative task may be performed using the tensor core (also refers to tensor computing core) in the target computing unit to obtain the target collaborative feature.

In operation S506, a feature integration operation may be performed. For example, the target collaborative feature may be added to the target basic feature to obtain the next target feature to be processed.

In a case that the determination result of operation S503 is no, operation S505 may be executed, where CUDA (Compute Unified Device Architecture) core performs a computation. For example, the CUDA core in the target computing unit may be used to perform the first collaborative task and the second collaborative task to obtain the target collaborative feature. Next, the operation S506 is performed to obtain the next target feature to be processed.

According to embodiments of the present disclosure, by determining the dimensions of the target features to be processed and calling corresponding type of computing core in the target computing unit to perform a collaborative computing task according to the determination results, the computing core architecture of the target computing unit (such as GPU) may be fully utilized, so as to improve the execution efficiency of tasks of the large model.

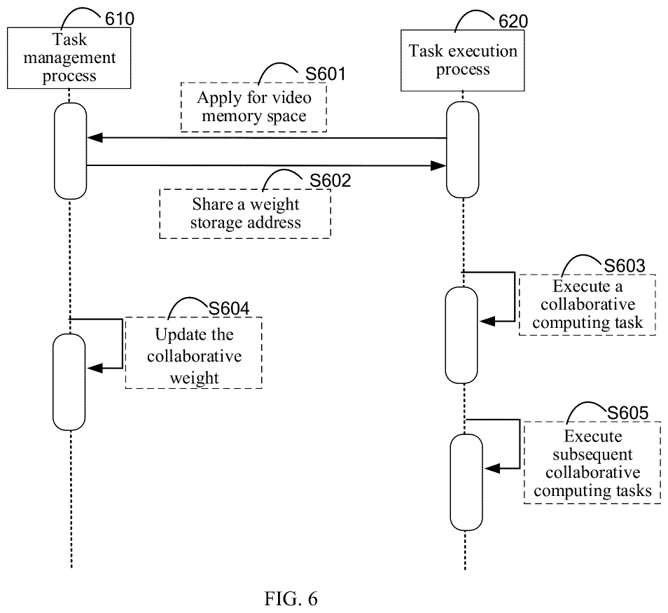

FIG. 6 schematically shows a diagram of an application scene of a task execution method for a large model according to an embodiment of the present disclosure.

As shown in FIG. 6, the task execution method for a large model may be implemented by setting a task management process 610 and a task execution process 620. The task execution process 620 may perform operation S601 and apply for video memory space from the task management process 610.

The task management process 620 may perform operation S602 to share a weight storage address of the collaborative weight with the task execution process 620. The task execution process 620 may perform operation S603 to execute a collaborative computing task. For example, the shared weight storage address may be used to call the first collaborative sub-weight or the second collaborative sub-weight from the video memory in the target computing unit to execute the first collaborative sub-task or the second collaborative sub-task.

The task management process 610 may also perform operation S604 to update the collaborative weight. For example, a weight matrix of at least one of the first collaborative sub-weight or the second collaborative sub-weight may be updated. When the task execution process 620 executes operation S605 and subsequent collaborative computing tasks, the updated first collaborative sub-weight or the updated second collaborative sub-weight may be called from the video memory in the target computing unit through the weight storage address previously shared based on the task management process, so as to execute the first collaborative sub-task or execute the second collaborative sub-task.

According to embodiments of the present disclosure, through sharing the weight storage address and updating the first collaborative sub-weight and the second collaborative sub-weight by the task management process, the task execution process may asynchronously load the updated first collaborative sub-weight to execute collaborative computing tasks or load the updated second collaborative sub-weight to execute collaborative computing tasks without perception, thereby achieving hot updating of the first collaborative sub-weight and the second collaborative sub-weight during the process of executing tasks of the large model, reducing the computation time generated by updating the weight storage.

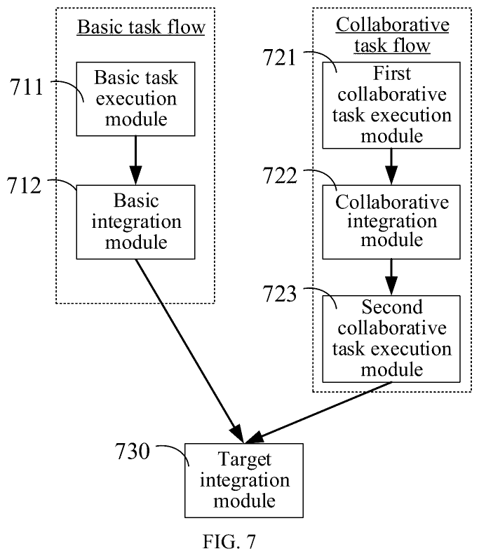

FIG. 7 schematically shows a schematic diagram of a principle of a task execution method for a large model according to another embodiment of the present disclosure.

As shown in FIG. 7, the target feature to be processed of the large model may be input into a basic task execution module 711 and a first collaborative task execution module 721, respectively. The basic task execution module 711 may process the target feature to be processed by executing a basic computing task, and the obtained computation result may be input into a basic integration module 712 for integration to obtain a target basic feature. The first collaborative task execution module 721 may process the target feature to be processed by executing a plurality of first collaborative sub-tasks to obtain a plurality of first intermediate collaborative features. The plurality of first intermediate collaborative sub-features may be input into a collaborative integration module 722 for integration to obtain a plurality of second intermediate collaborative sub-features. The plurality of second intermediate collaborative sub-features are input into a second collaborative task execution module 723. The second collaborative task execution module 723 may execute a plurality of second collaborative sub-tasks to obtain a plurality of second intermediate collaborative sub-features. The target basic feature and the plurality of second intermediate sub-features may be sent to a target integration module 730 to obtain a next target feature to be processed.

As shown in FIG. 7, a basic task flow for executing the basic computing task by the basic model may be implemented based on the basic task execution module 711 and the basic integration module 712. A collaborative task flow for executing collaborative computing tasks may be implemented based on the first collaborative task execution module 721, the collaborative integration module 722, and the second collaborative task execution module 723.

According to embodiments of the present disclosure, the target feature to be processed includes a target text feature to be processed. An initial feature is determined according to an initial text. An execution result obtained by the target computing unit executing the basic computing task and the collaborative computing task executed is an output text corresponding to the initial text.

For example, the initial text may be a query text input by the user, and the output text may be an answer text corresponding to the query text.

It may be understood that the input data for the large model being text is taken as an example to explain the present disclosure in the previous text. However, the present disclosure is not limited to this, and the input data for the large model may also be images or audios.

In some embodiments, the target feature to be processed is a target image feature to be processed. The initial feature is obtained according to an initial image. An execution result obtained by the target computing unit executing a plurality of basic computing tasks and a plurality of collaborative computing tasks is an output result corresponding to the initial image. The result may be an adjusted image or a text. In a case that the input data is an image, the input image may be processed based on patch embedding to obtain the target image feature to be processed. The above-mentioned target feature to be processed may include edges and colors in the image.

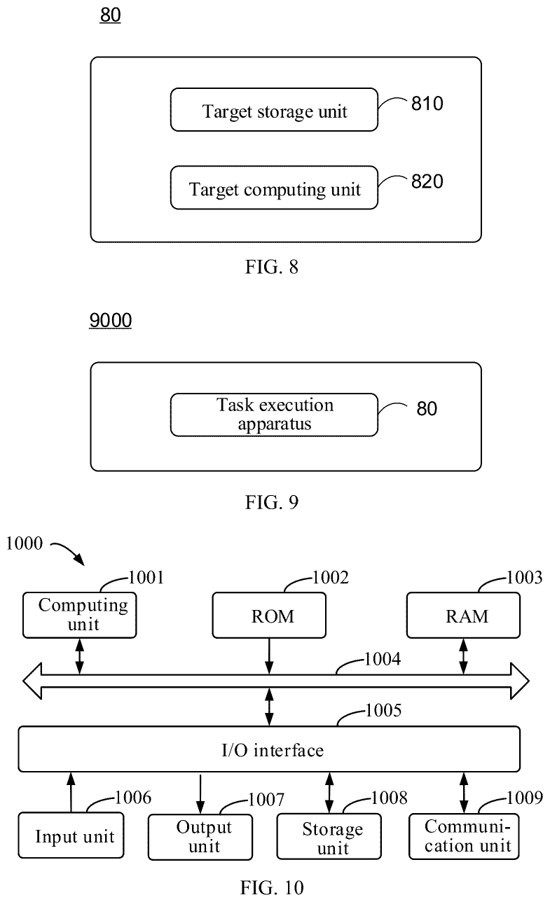

FIG. 8 schematically shows a block diagram of a task execution apparatus for a large model according to an embodiment of the present disclosure.

As shown in FIG. 8, the task execution apparatus 80 for a large model may include a target storage unit 810 and a target computing unit 820.

The target storage unit 810 is used to store a collaborative computing task.

The target computing unit 820 is configured to: execute a collaborative computing task to obtain a target collaborative feature according to a target feature to be processed, where the collaborative computing task includes a first collaborative task and a second collaborative task, the first collaborative task is used to process the target feature to be processed and a first collaborative sub-weight to obtain an intermediate collaborative feature, the second collaborative task is used to process the intermediate collaborative feature and a second collaborative sub-weight to obtain the target collaborative feature, and the first collaborative sub-weight and the second collaborative sub-weight are determined by processing a collaborative weight according to a matrix multiplication mechanism of a general matrix; and fuse a target basic feature and the target collaborative feature to obtain a next target feature to be processed, where the target basic feature is obtained by executing a basic computing task using the target computing unit, and the basic computing task is used to process a basic weight and the target feature to be processed.

According to embodiments of the present disclosure, the first collaborative task includes a plurality of first collaborative sub-tasks.

According to embodiments of the present disclosure, the target computing unit is further configured to execute the collaborative computing task according to the target feature to be processed, by: reading the first collaborative sub-weight and a target sub-feature to be processed corresponding to a first collaborative sub-task from a target storage unit, where the target sub-feature to be processed is obtained by dividing the target feature to be processed; and executing the first collaborative sub-task using the target computing unit based on the first collaborative sub-weight and the target sub-feature to be processed to obtain a first intermediate collaborative sub-feature, where the intermediate collaborative feature is determined according to first intermediate collaborative sub-features corresponding to the plurality of first collaborative sub-tasks respectively.

According to embodiments of the present disclosure, the plurality of first collaborative sub-tasks are associated with the same first collaborative sub-weight.

According to embodiments of the present disclosure, the second collaborative task includes a plurality of second collaborative sub-tasks.

According to embodiments of the present disclosure, the target computing unit is further configured to execute the collaborative computing task according to the target feature to be processed, by: reading a second intermediate collaborative sub-feature corresponding to a second collaborative sub-task from a target storage unit, where the second intermediate collaborative sub-feature is determined according to the intermediate collaborative feature; and executing the second collaborative sub-task based on the second intermediate collaborative sub-feature and the second collaborative sub-weight to obtain a target collaborative sub-feature, where the target collaborative feature is determined according to target collaborative sub-features corresponding to the plurality of second collaborative sub-tasks respectively.

According to embodiments of the present disclosure, the plurality of second collaborative sub-tasks are associated with the same second collaborative sub-weight.

According to embodiments of the present disclosure, the target feature to be processed is determined according to an initial feature.

According to embodiments of the present disclosure, the target feature to be processed may be obtained by the target computing unit executing a previous collaborative computing task and a previous basic computing task.

According to embodiments of the present disclosure, the target feature to be processed includes a target text feature to be processed. The initial feature is determined according to an initial text, and an execution result of the target computing unit executing the basic computing task and collaborative computing task is an output text corresponding to the initial text.

FIG. 9 schematically shows a block diagram of a task execution device for a large model according to an embodiment of the present disclosure.

As shown in FIG. 9, the task execution device 9000 for a large model may include the task execution apparatus 80 for a large model.

In the technical solution of the present disclosure, collecting, storing, using, processing, transmitting, providing and disclosing etc. of the personal information of the user involved in the present disclosure all comply with the relevant laws and regulations, and do not violate the public order and morals.

According to the embodiments of the present disclosure, the present disclosure also provides an electronic device, a readable storage medium and a computer program product.

According to embodiments of the present disclosure, an electronic device is provided, including at least one processor; and a memory communicatively coupled to the at least one processor, where the memory stores instructions executable by the at least one processor, and the instructions, when executed by the at least one processor, cause the at least one processor to implement the method as described above.

According to embodiments of the present disclosure, a non-transitory computer-readable storage medium storing computer instructions is provided, where the computer instructions are used to cause a computer to implement the method as described above.

According to embodiments of the present disclosure, a computer program product is provided, including a computer program, where the computer program, when executed by a processor, implements the method as described above.

FIG. 10 schematically shows a block diagram of an electronic device that may be used to implement a task execution method for a large model according to an embodiment of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, an electronic device 1000 may include a computing unit 1001, which may perform various appropriate actions and processing based on a computer program stored in a read-only memory (ROM) 1002 or a computer program loaded from a storage unit 1008 into a random access memory (RAM) 1003. Various programs and data required for the operation of the electronic device 1000 may be stored in the RAM 1003. The computing unit 1001, the ROM 1002 and the RAM 1003 are connected to each other through a bus 1004. An input/output (I/O) interface 1005 is further connected to the bus 1004.

Various components in the electronic device 1000 are connected with I/O interface 1005, including an input unit 1006, such as a keyboard, a mouse, etc.; an output unit 1007, such as various types of displays, speakers, etc.; a storage unit 1008, such as a magnetic disk, an optical disk, etc.; and a communication unit 1009, such as a network card, a modem, a wireless communication transceiver, etc. The communication unit 1009 allows the electronic device 1000 to exchange information/data with other devices through a computer network such as the Internet and/or various telecommunication networks.

The computing unit 1001 may be various general-purpose and/or special-purpose processing components with processing and computing capabilities. Some examples of the computing unit 1001 include but are not limited to a central processing unit (CPU), a graphics processing unit (GPU), various specialized artificial intelligence (AI) computing chips, various computing units running machine learning model algorithms, a digital signal processor (DSPs), and any appropriate processor, controller, microcontroller, and so on. The computing unit 1001 may perform the various methods and processes described above, such as the task execution method for a large model. For example, in some embodiments, the task execution method for a large model may be implemented as a computer software program that is tangibly contained on a machine-readable medium, such as a storage unit 1008. In some embodiments, part or all of a computer program may be loaded and/or installed on the electronic device 1000 via the ROM 1002 and/or the communication unit 1009. When the computer program is loaded into the RAM 1003 and executed by the computing unit 1001, one or more steps of the task execution method for a large model described above may be performed. Alternatively, in other embodiments, the computing unit 1001 may be configured to perform the task execution method for a large model in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described herein may be implemented on a computer including a display device (for example, a CRT (cathode ray tube) or LCD (liquid crystal display) monitor) for displaying information to the user; and a keyboard and a pointing device (for example, a mouse or a trackball), through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A task execution method for a large model, comprising:
executing, according to a target feature to be processed, a collaborative computing task using at least one processor to obtain a target collaborative feature, wherein the collaborative computing task comprises a first collaborative task and a second collaborative task, the first collaborative task is configured to process the target feature to be processed and a first collaborative sub-weight to obtain an intermediate collaborative feature, the second collaborative task is configured to process the intermediate collaborative feature and a second collaborative sub-weight to obtain the target collaborative feature, and the first collaborative sub-weight and the second collaborative sub-weight are determined by processing a collaborative weight according to a matrix multiplication mechanism of a general matrix; and
fusing a target basic feature and the target collaborative feature to obtain a next target feature to be processed, wherein the target basic feature is obtained by executing a basic computing task using the at least one processor, and the basic computing task is configured to process a basic weight and the target feature to be processed.

2. The method of claim 1, wherein the first collaborative task comprises a plurality of first collaborative sub-tasks;
wherein executing the collaborative computing task using the at least one processor according to the target feature to be processed comprises:
reading the first collaborative sub-weight and a target sub-feature to be processed corresponding to a first collaborative sub-task from a memory using the at least one processor, wherein the target sub-feature to be processed is obtained by dividing the target feature to be processed; and
executing the first collaborative sub-task using the at least one processor based on the first collaborative sub-weight and the target sub-feature to be processed to obtain a first intermediate collaborative sub-feature, wherein the intermediate collaborative feature is determined according to first intermediate collaborative sub-features corresponding to the plurality of first collaborative sub-tasks respectively.

3. The method of claim 2, wherein the plurality of first collaborative sub-tasks are associated with the same first collaborative sub-weight.

4. The method of claim 1, wherein the second collaborative task comprises a plurality of second collaborative sub-tasks;
wherein executing the collaborative computing task using the at least one processor according to the target feature to be processed further comprises:
reading a second intermediate collaborative sub-feature corresponding to a second collaborative sub-task from a memory using the at least one processor, wherein the second intermediate collaborative sub-feature is determined according to the intermediate collaborative feature; and
executing the second collaborative sub-task using the at least one processor based on the second intermediate collaborative sub-feature and the second collaborative sub-weight to obtain a target collaborative sub-feature, wherein the target collaborative feature is determined according to target collaborative sub-features corresponding to the plurality of second collaborative sub-tasks respectively.

5. The method of claim 4, wherein the plurality of second collaborative sub-tasks are associated with the same second collaborative sub-weight.

6. The method of claim 1, wherein
the target feature to be processed is determined according to an initial feature; or
the target feature to be processed is obtained by the at least one processor executing a previous collaborative computing task and a previous basic computing task.

7. The method of claim 6, wherein the target feature to be processed comprises a target text feature to be processed, the initial feature is determined according to an initial text, and an execution result of the at least one processor executing the basic computing task and the collaborative computing task is an output text corresponding to the initial text.

8. The method of claim 2, wherein the second collaborative task comprises a plurality of second collaborative sub-tasks;
wherein executing the collaborative computing task using the at least one processor according to the target feature to be processed further comprises:
reading a second intermediate collaborative sub-feature corresponding to a second collaborative sub-task from a memory using the at least one processor, wherein the second intermediate collaborative sub-feature is determined according to the intermediate collaborative feature; and
executing the second collaborative sub-task using the at least one processor based on the second intermediate collaborative sub-feature and the second collaborative sub-weight to obtain a target collaborative sub-feature, wherein the target collaborative feature is determined according to target collaborative sub-features corresponding to the plurality of second collaborative sub-tasks respectively.

9. The method of claim 8, wherein the plurality of second collaborative sub-tasks are associated with the same second collaborative sub-weight.

10. The method of claim 3, wherein the second collaborative task comprises a plurality of second collaborative sub-tasks;
wherein executing the collaborative computing task using the at least one processor according to the target feature to be processed further comprises:
reading a second intermediate collaborative sub-feature corresponding to a second collaborative sub-task from a memory using the at least one processor, wherein the second intermediate collaborative sub-feature is determined according to the intermediate collaborative feature; and
executing the second collaborative sub-task using the at least one processor based on the second intermediate collaborative sub-feature and the second collaborative sub-weight to obtain a target collaborative sub-feature, wherein the target collaborative feature is determined according to target collaborative sub-features corresponding to the plurality of second collaborative sub-tasks respectively.

11. The method of claim 10, wherein the plurality of second collaborative sub-tasks are associated with the same second collaborative sub-weight.

12. An electronic device, comprising:
at least one processor; and
a memory communicatively coupled with the at least one processor,
wherein the memory stores instructions executable by the at least one processor, and the instructions, when executed by the at least one processor, cause the at least one processor to:
execute, according to a target feature to be processed, a collaborative computing task to obtain a target collaborative feature, wherein the collaborative computing task comprises a first collaborative task and a second collaborative task, the first collaborative task is configured to process the target feature to be processed and a first collaborative sub-weight to obtain an intermediate collaborative feature, the second collaborative task is configured to process the intermediate collaborative feature and a second collaborative sub-weight to obtain the target collaborative feature, and the first collaborative sub-weight and the second collaborative sub-weight are determined by processing a collaborative weight according to a matrix multiplication mechanism of a general matrix; and
fuse a target basic feature and the target collaborative feature to obtain a next target feature to be processed, wherein the target basic feature is obtained by executing a basic computing task using the at least one processor, and the basic computing task is configured to process a basic weight and the target feature to be processed.

13. The electronic device of claim 12, wherein the first collaborative task comprises a plurality of first collaborative sub-tasks;
wherein the at least one processor is further configured to:
read the first collaborative sub-weight and a target sub-feature to be processed corresponding to a first collaborative sub-task from the memory, wherein the target sub-feature to be processed is obtained by dividing the target feature to be processed; and
execute the first collaborative sub-task based on the first collaborative sub-weight and the target sub-feature to be processed to obtain a first intermediate collaborative sub-feature, wherein the intermediate collaborative feature is determined according to first intermediate collaborative sub-features corresponding to the plurality of first collaborative sub-tasks respectively.

14. The electronic device of claim 13, wherein the plurality of first collaborative sub-tasks are associated with the same first collaborative sub-weight.

15. The electronic device of claim 12, wherein the second collaborative task comprises a plurality of second collaborative sub-tasks;
wherein the at least one processor is further configured to:
read a second intermediate collaborative sub-feature corresponding to a second collaborative sub-task from the memory, wherein the second intermediate collaborative sub-feature is determined according to the intermediate collaborative feature; and
execute the second collaborative sub-task based on the second intermediate collaborative sub-feature and the second collaborative sub-weight to obtain a target collaborative sub-feature, wherein the target collaborative feature is determined according to target collaborative sub-features corresponding to the plurality of second collaborative sub-tasks respectively.

16. The electronic device of claim 15, wherein the plurality of second collaborative sub-tasks are associated with the same second collaborative sub-weight.

17. The electronic device of claim 12, wherein
the target feature to be processed is determined according to an initial feature; or
the target feature to be processed is obtained by the at least one processor executing a previous collaborative computing task and a previous basic computing task.

18. The electronic device of claim 17, wherein the target feature to be processed comprises a target text feature to be processed, the initial feature is determined according to an initial text, and an execution result of the at least one processor executing the basic computing task and the collaborative computing task is an output text corresponding to the initial text.

19. The electronic device of claim 13, wherein the second collaborative task comprises a plurality of second collaborative sub-tasks;
wherein the at least one processor is further configured to:
read a second intermediate collaborative sub-feature corresponding to a second collaborative sub-task from the memory, wherein the second intermediate collaborative sub-feature is determined according to the intermediate collaborative feature; and
execute the second collaborative sub-task based on the second intermediate collaborative sub-feature and the second collaborative sub-weight to obtain a target collaborative sub-feature, wherein the target collaborative feature is determined according to target collaborative sub-features corresponding to the plurality of second collaborative sub-tasks respectively.

20. A non-transitory computer readable storage medium storing computer instructions, wherein the computer instructions are configured to cause a computer to:
execute, according to a target feature to be processed, a collaborative computing task using at least one processor to obtain a target collaborative feature, wherein the collaborative computing task comprises a first collaborative task and a second collaborative task, the first collaborative task is configured to process the target feature to be processed and a first collaborative sub-weight to obtain an intermediate collaborative feature, the second collaborative task is configured to process the intermediate collaborative feature and a second collaborative sub-weight to obtain the target collaborative feature, and the first collaborative sub-weight and the second collaborative sub-weight are determined by processing a collaborative weight according to a matrix multiplication mechanism of a general matrix; and
fuse a target basic feature and the target collaborative feature to obtain a next target feature to be processed, wherein the target basic feature is obtained by executing a basic computing task using at least one processor, and the basic computing task is configured to process a basic weight and the target feature to be processed.
